(19) United States
(12) Patent Application Publication
(10) Pub. No.: US 2022/0361098 A1
(43) Pub. Date: Nov. 10, 2022

(54) METHOD RELATED TO EMERGENCY SERVICE AND USER EQUIPMENT

(71) Applicant: FG Innovation Company Limited, New Territories (HK)

(72) Inventors: Mei-Ju Shih, Taipei City (TW); Hung-Chen Chen, Taipei City (TW)

(73) Assignee: FG Innovation Company Limited, New Territories (HK)

(21) Appl. No.: 17/735,131

(22) Filed: May 3, 2022

Related U.S. Application Data
(60) Provisional application No. 63/184,050, filed on May 4, 2021.

(51) Int. Cl. H04W 48/18; H04W 4/90; H04W 60/04; H04W 76/50; H04W 76/20

(52) U.S. Cl. CPC H04W 48/18; H04W 4/90; H04W 60/04; H04W 76/50; H04W 76/20; H04W 84/042

(57) ABSTRACT

A method related to emergency service and a user equipment (UE) are provided. In the method, SNPN access mode is operated. A SNPN selection for a selected SNPN is performed in response to operating in the SNPN AM. A cell selection for a selected cell is performed in response to the SNPN selection. A support indication associated with the selected SNPN is received in response to the cell selection. The support indication indicates whether the selected SNPN supports IMS emergency service. The support indication is forwarded to a NAS layer of the UE from a RRC layer of the UE when the support indication indicates that the selected SNPN supports the IMS emergency service. The cell selection is performed for an acceptable cell of another SNPN supporting the IMS emergency service when the support indication indicates that the selected SNPN does not support the IMS emergency service.

### CROSS-REFERENCE TO RELATED APPLICATION(S)

The present application claims the benefit of and priority to U.S. Provisional Patent Application Ser. No. 63/184,050, filed on May 4, 2021, entitled “METHOD AND APPARATUS FOR EMERGENCY SERVICES IN NON-PUBLIC NETWORK” with Attorney Docket No. US84909, the content of which is hereby incorporated fully by reference herein into the present disclosure.

### FIELD

The present disclosure generally relates to wireless communications, and more particularly, to a method related to emergency service and a user equipment (UE).

### BACKGROUND

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

In order to fulfill the low latency and high reliability requirements for the vertical industry and support 5G LAN (Local Area Network)-type service, a dedicated wireless network, i.e., a private network, attracts attention to be included in the next-generation cellular network.

The private network (e.g., non-public network (NPN)) may realize the support of vertical and LAN services. The private network may be classified into a standalone non-public network (SNPN) and a public network integrated non-public network (PNI-NPN). Operators may focus on the PNI-NPN solutions applicable for a much wide range of use cases such as SOHO (Small Office Home Office) and residential, private network coverage deployments, and so on.

5G system (5GS) will be enhanced to support NPN. Two network identifiers are introduced for NPN: Network ID (MD) and Closed Access Group (CAG) ID. 5G RAN (Radio Access Network) may also implement NPN by enhancing the features such as non-public network identification, discovery, selection/reselection, access control and mobility restrictions. 5GS functionalities are continuously be enhanced to enable more efficient support of non-public networks and simplification of 5G system for non-public networks.

However, legacy NPN does not support emergency services and eCall over IMS.

### SUMMARY

The present disclosure is directed to a method related to emergency service and a user equipment (UE).

According to one or more exemplary embodiments of the disclosure, a method related to emergency service used for a UE is provided. The method includes, but is not limited to, the following steps. Standalone non-public network (SNPN) access mode (AM) is operated. A SNPN selection for a selected SNPN is performed in response to operating in the SNPN AM. A cell selection for a selected cell is performed in response to the SNPN selection. A support indication associated with the selected SNPN is received in response to the cell selection. The support indication indicates whether the selected SNPN supports IP multimedia subsystem (IMS) emergency service. The support indication is forwarded to a non-access stratum (NAS) layer of the UE from a radio resource control (RRC) layer of the UE when the support indication indicates that the selected SNPN supports the IMS emergency service. The cell selection is performed for an acceptable cell of another SNPN supporting the IMS emergency service when the support indication indicates that the selected SNPN does not support the IMS emergency service.

According to one or more exemplary embodiments of the disclosure, a UE is provided. The UE includes, but is not limited to, a transceiver, a memory, and a processor. The transceiver is used for transmitting or receiving signals. The memory is used for storing instruction. The processor is coupled to the transceiver and the memory. The processor is configured to execute the instruction to perform: operating in SNPN AM; performing a SNPN selection for a selected SNPN in response to operating in the SNPN AM; performing a cell selection for a selected cell in response to the SNPN selection; receiving a support indication associated with the selected SNPN in response to the cell selection; forwarding the support indication from a RRC layer of the UE to a NAS layer of the UE when the support indication indicates that the selected SNPN supports the IMS emergency service; and performing the cell selection for an acceptable cell of another SNPN supporting the IMS emergency service when the support indication indicates that the selected SNPN does not support the IMS emergency service. The support indication indicates whether the selected SNPN supports IMS emergency service.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 is a flow chart that illustrates a method related to emergency service according to one of the exemplary embodiments of the disclosure.

FIG. 2 is a block diagram illustrating a node for wireless communication, according to one of the exemplary embodiments of the disclosure.

### DETAILED DESCRIPTION

The acronyms in the present disclosure are defined as follows and unless otherwise specified, the acronyms have the following meanings:

| Acronym | Full name |
|---|---|
| 3GPP | 3^{rd} Generation Partnership Project |
| 5GC | 5G Core |
| ACK | Acknowledgement |
| AMF | Access and Mobility Management Function |
| ARQ | Automatic Repeat Request |
| AS | Access Stratum |
| BS | Base Station |
| BWP | Bandwidth Part |
| CA | Carrier Aggregation |
| CAG | Closed Access Group |
| CMAS | Commercial Mobile Alert System |
| CN | Core Network |
| CORESET | Control Resource Set |
| C-RNTI | Cell-Radio Network Temporary Identifier |
| DC | Dual Connectivity |
| DCI | Downlink Control Information |
| DL | Downlink |
| EPC | Evolved Packet Core |
| ETWS | Earthquake and Tsunami Warning System |
| HARQ | Hybrid Automatic Repeat Request |
| IE | Information Element |
| IMS | IP Multimedia Subsystem |
| LTE | Long Term Evolution |
| MAC | Medium Access Control |
| MCG | Master Cell Group |
| MIB | Master Information Block |
| MIMO | Multiple Input Multiple Output |
| NAS | Non-Access Stratum |
| NG-RAN | Next-Generation Radio Access Network |
| NPN | Non-Public Network |
| NR | New Radio |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PNI-NPN | Public Network Integrated Non-Public Network |
| PRACH | Physical Random Access Channel |
| PSCell | Primary Secondary Cell Group Cell |
| PUCCH | Physical Uplink Control Channel |
| PUSCH | Physical Uplink Shared Channel |
| QoS | Quality of Service |
| RA | Random Access |
| RACH | Random Access Channel |
| RAN | Radio Access Network |
| RAT | Radio Access Technology |
| Rel | Release |
| RLC | Radio Link Control |
| RNTI | Radio Network Temporary Identifier |
| RRC | Radio Resource Control |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| SNPN | Standalone Non-Public Network |
| SpCell | Special Cell |
| TS | Technical Specification |
| UCI | Uplink Control Information |
| UE | User Equipment |
| UL | Uplink |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station may include, but is not limited to, a node B (NB) as in the UNITS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more S Cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation (CA) between licensed band NR (PCell) and NR-U (SCell), dual connectivity (DC) between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PS Cell may belong to the SN. A Special Cell (SpCell) may be referred to a PCell of the MCG, or a PS Cell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, a UE in an RRC CONNECTED state that is not configured with the CA/DC, may communicate with only one serving cell (S Cell) which may be the primary cell. Conversely, for a UE in the RRC_CONNECTED state that is configured with the CA/DC a set of serving cells including the special cell(s) and all of the secondary cells may communicate with the UE.

Some related technologies are introduced first.

In the disclosure, the network (NW), Radio Access Network (RAN), cell, camped cell, serving cell, base station, gNB, eNB and ng-eNB interchangeably may be used. In some implementations, some of these items may refer to the same network entity.

Serving Cell: For a UE in RRC_CONNECTED not configured with CA/DC there is only one serving cell including the primary cell. For a UE in RRC CONNECTED configured with CA/DC the term ‘serving cells’ is used to denote the set of cells including the Special Cell(s) and all secondary cells.

Special Cell: For Dual Connectivity operation the term Special Cell refers to the PCell of the MCG or the PS Cell of the SCG, otherwise the term Special Cell refers to the PCell.

The proposed mechanism may be applied to any RAT. The RAT may be (but not limited to) NR, NR-U, LTE, E-UTRA connected to 5GC, LTE connected to 5GC, E-UTRA connected to EPC, and LTE connected to EPC. The proposed mechanism may be applied for UEs in public networks, or in private network (e.g., NPN (non-public network, SNPN (standalone NPN), PNI-NPN (public network integrated NPN)).

In one or more embodiments, the proposed method may be used for licensed frequency and/or unlicensed frequency.

System information (SI) may refer to MIB, SIB1, and other SI. Minimum SI may include MIB and SIB1. Other SI may refer to SIB3, SIB4, SIBS, and other SIB(s) (e.g., SNPN-specific SIB, or PM-NPN-specific SIB).

Dedicated signaling may refer to (but not limited to) RRC message(s). For example, RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message. RRC message may be one kind of dedicated signaling. The UE may receive the RRC message from the network via unicast/broadcast.

In one or more embodiments, a UE may be operating in RRC CONNECTED, RRC INACTIVE, or RRC IDLE state.

In one or more embodiments, the BS, the PCell and the UE may perform the proposed method, which would be introduced later. In some embodiments, the BS, the PSCell and the UE may perform the proposed method.

Non-Public Network: A network deployed for non-public use.

NPN-only Cell: A cell that is only available for normal service for NPNs' subscriber. An NPN-capable UE determines that a cell is NPN-only Cell by detecting that the cellReservedForOtherU se IE is set to true while the npn-IdentityInfoList IE is present in CellAccessRelatedInfo IE.

PNI-NPN identity: An identifier of a PNI-NPN compromising of a PLMN ID and a CAG -ID combination.

Registered SNPN: This is the SNPN on which certain Location Registration outcomes have occurred.

Selected SNPN: This is the SNPN that has been selected by the NAS (e.g., the NAS of the UE, the NAS of the CN), either manually or automatically.

SNPN Access Mode: Mode of operation wherein the UE only selects SNPNs.

SNPN identity: An identifier of an SNPN including a PLMN ID and an MD combination.

SNPN-only cell: A cell that is only available for normal service for SNPN subscribers. A cell that is available for normal service and limited service for SNPN subscribers.

An NPN-capable UE may correspond to a UE supporting CAG (or NPN).

Multi-Radio Dual Connectivity (MR-DC): Dual Connectivity between E-UTRA and NR nodes, or between two NR nodes. MR-DC may include E-UTRA-NR Dual Connectivity (EN-DC), NR-E-UTRA Dual Connectivity (NE-DC), NG-RAN E-UTRA-NR Dual Connectivity (NGEN-DC), and NR-NR Dual Connectivity (NR-DC).

Master Cell Group: In MR-DC, a group of serving cells associated with the Master Node, including the SpCell (PCell) and optionally one or more SCells.

Master node: In MR-DC, the radio access node that provides the control plane connection to the core network. It may be a Master eNB (in EN-DC), a Master ng-eNB (in NGEN-DC) or a Master gNB (in NR-DC and NE-DC).

Secondary Cell Group: In MR-DC, a group of serving cells associated with the Secondary Node, including the SpCell (PSCell) and optionally one or more SCells.

Secondary node: In MR-DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

MeNB: Master eNB, an eNB as a master node associated to an MCG (Master Cell Group) in MR-DC scenarios.

SgNB: Secondary gNB, a gNB as a secondary node associated to an SCG (Secondary Cell Group) in MR-DC scenarios.

SNPN cell: A cell that supports SNPN, or a cell operated by SNPN. The cell may broadcast the SNPN ID, identifying a SNPN network that the cell supports. It is possible that the SNPN cell may also broadcast the PLMN ID, identifying a PLMN network that the cell supports, especially in a RAN sharing or network sharing case. It is possible that the SNPN cell may also broadcast the PNI-NPN ID, identifying a PNI-NPN network that the cell supports, especially in a RAN sharing or network sharing case. That is, the SNPN cell may broadcast not only SNPN ID(s) but also PLMN ID(s) and/or PNI-NPN ID(s).

PLMN cell: A cell that supports PLMN, or a cell operated by PLMN. The cell may broadcast the PLMN ID, identifying a PLMN network that the cell supports. It is possible that the PLMN cell may also broadcast the SNPN ID, identifying an SNPN network that the cell supports, especially in a RAN sharing or network sharing case. It is possible that the SNPN cell may also broadcast the PNI-NPN ID, identifying a PNI-NPN network that the cell supports, especially in a RAN sharing or network sharing case. That is, the PLMN cell may broadcast not only PLMN ID(s) but also SNPN ID(s) and/or PM-NPN ID(s).

The cell supporting (at least) one SNPN (e.g., SNPN cell) may broadcast in SIB1 at least one SNPN identity, identifying a SNPN.

The cell supporting (at least) one PLMN (e.g., PLMN cell) may broadcast in SIB1 at least one PLMN identity, identifying a PLMN.

The cell in this disclosure may refer to a cell supporting 3GPP Release 17 and/or beyond. The cell in this disclosure may refer to a cell supporting at least SNPN. The cell in this disclosure may refer to a cell supporting only SNPN. The cell in this disclosure may refer to a cell supporting at least PLMN. The cell in this disclosure may refer to a cell supporting only PLMN.

‘A UE may not receive something’ may be equivalent to ‘A UE may ignore or disable something’.

Emergency Services:

Emergency services, used for the support of IMS emergency sessions, refer to functionalities provided by the serving network when the network is configured to support emergency services. For example, an IMS emergency call or an eCall over IMS. Emergency services can be applied by the normally registered UEs and by the emergency registered UEs, that can be either normally registered or in limited service state.

NG-RAN provides support for Emergency Services either directly by itself or through fallback mechanisms towards a different RAT (e.g., from NR connected to 5GC to E-UTRA connected to 5GC) or towards a different core network system (e.g., from NR connected to 5GC to E-UTRAN in EPC, from E-UTRA connected to 5GC to E-UTRAN in EPC).

Emergency services may include IMS emergency call and eCall over IMS. The UE may be provided with an IMS emergency call support indication (e.g., ims-EmergencySupport) indicating whether the emergency bearer services are supported. The UE may be provided with an eCall over IMS support indication (e.g., eCallOverIMS-Support) indicating whether the eCall over IMS is supported.

A UE in normal service state:

The UE in normal service state may receive an Emergency Service Support indicator in a NAS message (e.g., Registration Accept message) in the Registration procedure, Attach procedure, and Tracking Area Update procedure. If the PLMN supports emergency services, the AMF may include an Emergency Service Support indicator in a NAS message, and the AMF may transmit the NAS message to the UE via a serving cell.

The UE in normal service state may receive an eCall over IMS support indication included in system information (e.g., SIB1) from a cell that the UE camps on or connects to determine whether the cell and/or the network supports eCall over IMS. The cell may set an eCall over IMS support indication to “true” or “support” if the PLMN in a non-shared environment or all PLMNs in a shared environment supports eCall over IMS.

Upon (the RRC layer of) the UE receiving the eCall over IMS support indication if present, (the RRC layer of) the UE may forward the eCall over IMS support indication to the upper layers of the UE (e.g., the NAS layer of the UE).

A UE in limited service state:

The UE in limited service state may determine whether a cell supports emergency service over NG-RAN based on the IMS emergency call support indication (e.g., ims-EmergencySupport) included in system information (e.g., SIB1) received from a cell that the UE camps on. The cell may set the IMS emergency call support indication to “true” or “support” if any AMF in a non-shared environment or at least one of the PLMNs in a shared environment supports IMS emergency bearer services.

The UE in limited service may determine whether the cell and/or the network supports eCall over IMS based on the IMS emergency call support indication (e.g., ims-EmergencySupport) and the eCall over IMS support indication (e.g., eCallOverIMS-Support) included in system information (e.g., SIB1) received from a cell that the UE camps on. The cell may set an eCall over IMS support indication to “true” or “support” if the PLMN in a non-shared environment or all PLMNs in a shared environment supports eCall over IMS.

Upon (the RRC layer of) the UE receiving the eCall over IMS support indication and/or the IMS emergency call support indication if present, (the RRC layer of) the UE may forward the eCall over IMS support indication and/or the IMS emergency call support indication to the upper layers of the UE (e.g., the NAS layer of the UE).

For emergency services over 3GPP access, other than eCall over IMS, a UE in limited service state may determine that the cell supports emergency services over NR-RAN based on the broadcast indicator, i.e., the IMS emergency call support indication, in AS.

It is noted that a UE in normal service state and a UE in limited service state may base on different indications, i.e., one from the broadcast system information and another one from the NAS message, to determine whether the cell and the network support the IMS emergency call.

The IMS emergency call support indication may indicate whether the cell broadcasting such indication supports IMS emergency bearer services for a UE in limited service state. If the indication is absent (e.g., a UE receiving the system information excluding the indication (i.e., the indication is absent)), the UE may determine that the IMS emergency call is not supported by the network/cell for the UE in limited service state.

The eCall over IMS support indication may indicate whether the cell broadcasting such indication supports eCall over IMS services. If the indication is absent (e.g., a UE receiving the system information excluding the indication (i.e., the indication is absent)), the UE may determine that the eCall over IMS service is not supported by the network/cell for the UE, either in normal service state or in limited service state.

It is noted that depending on local regulation, receiving emergency services in limited service state does not require a valid subscription. It is noted that depending on local regulation and on operator's policy, the network may allow or reject a registration request for emergency services (i.e., emergency registration) from UEs that have been identified to be in limited service state.

It is noted that emergency calls for eCall over IMS may only be performed if the UE has a USIM. A serving network may provide eCall over IMS support indication from E-UTRA connected to 5GC to UEs indicating whether eCall over IMS is supported:

When a cell is connected to EPC and 5GC, the cell broadcasts separate eCall over IMS support indication for 5GC and eCall over IMS support indication for EPC to indicate support of eCall over IMS by 5GC and EPC.

A UE that is not in limited service state (e.g., in normal service state) may determine that the E-UTRA cell supports eCall over IMS via 5GC using the eCall over IMS support indication. The UE may originate emergency calls for eCall over IMS only over E-UTRA connected to 5GC and may not originate emergency calls for eCall over IMS over NR.

A UE in limited service state may determine that the cell supports eCall over IMS using both the broadcast IMS emergency call support indication over E-UTRA connected to 5GC and eCall over IMS support indication for E-UTRA connected to 5GC. Emergency calls for eCall over IMS are not supported over NR and non-3GPP access. It is noted that the eCall over IMS support indication does not indicate whether a UE in limited service state is supported. Thus, the broadcast IMS emergency call support indication over E-UTRA connected to 5GC that indicates limited service state support needs to be additionally applied by the UE in limited service state when the UE in limited service state determines whether eCall over IMS is supported.

A UE configured for eCall Only Mode may remain in RM-DEREGISTERED state, may camp on a cell, but may refrain from any Registration Management, Connection Management or another signaling with the network. The eCall Only Mode is a UE configuration option that allows the UE to register at 5GC and register in IMS to perform only eCall over IMS and anon-emergency IMS call for test and/or terminal reconfiguration services.

To provide emergency services, the AMF in the 5GC is configured with Emergency Configuration Data that are applied to emergency services. The emergency services are established by an AMF based on request from the UE. The AMF Emergency Configuration Data includes the 5-NSSAI and Emergency DNN which is used to derive an SMF. Registration procedure and Emergency Registration procedure are designed to provide the UEs with emergency services from the core network and the NG-RAN.

Registration procedure:

Registration procedure is applied by a UE in normal service state to get the emergency services. During Registration procedure, in response to the Registration Request message transmitted by the UE in normal service state to the serving AMF via a serving cell, the serving AMF may transmit the Registration Accept message including an Emergency Service Support indicator to the UE camped normally in the serving cell (i.e., the UE is in normal service state). The UE is a normally registered UE. The Emergency Services Support indicator is valid within the current Registration Area per RAT. After receiving the Emergency Service Support indicator, the UE may setup emergency PDU Session to obtain emergency services. If any of the following conditions happen within the current Registration Area, the serving AMF may transmit the Registration Accept message including Emergency Service Support indicator to the UE:

The network is able to support emergency services over 5GS;

E-UTRA connected to 5GC supports IMS emergency services (e.g., voice), and the NG-RAN can trigger handover or redirection from NR to E-UTRA connected to 5GC at QoS Flow establishment for IMS emergency services;

NG-RAN can trigger handover to EPS at QoS Flow establishment for IMS emergency services; or NG-RAN can trigger redirection to EPS at QoS Flow establishment for IMS emergency services.

A UE that camps on a suitable cell in RM-DEREGISTERED state (e.g., the UE has not yet registered with the core network) may initiate the Initial Registration procedure for normal service instead of Emergency Registration, to receive emergency services. After successful registration, the UE may initiate the UE Requested PDU Session Establishment procedure with a Request Type indicating “Emergency Request” to receive emergency services if the serving AMF indicates the support for Emergency Services in 5GC. The UE camping normally on a cell may be informed that the PLMN supports Emergency Services over 5G-AN from the Emergency Service Support indicator in the Registration procedure.

Emergency Registration procedure:

For UEs in limited service state or for UEs camping normally on a cell but failing to register successfully to the network (i.e., UEs in normal service state but failing to register successfully to the network), the UE may initiate the Registration procedure by indicating that the registration is to receive emergency services, i.e., Emergency Registration. During the Emergency Registration, the UE may transmit a Registration Request message including a Follow-on request to initiate PDU Session Establishment procedure with a Request Type indicating “Emergency Request”.

The 5GC may transmit an indication (e.g., the support for emergency services fallback indicator) per RAT indicating whether the 5GC supports emergency services fallback to another RAT in 5GS or to another system supporting emergency services. Such indication per RAT indicating whether the 5GC supports emergency services fallback is valid within the current Registration Area per RAT. There are two types of emergency services fallback: RAT fallback, and E-UTRAN connected to EPC System fallback (i.e., Inter-system fallback).

RAT fallback:

When NR does not support emergency services, RAT fallback towards E-UTRAN connected to 5GC is performed. Depending on factors such as CN interface availability, network configuration and radio conditions, the fallback procedure results in either CONNECTED (e.g., RRC CONNECTED) state mobility (handover procedure) or IDLE (e.g., RRC IDLE) state mobility (redirection).

For an example of RAT fallback, when only NR does not support emergency services, the UE and 5GC may support the mechanism to direct or redirect the UE towards E-UTRA connected to 5GC.

Inter-system fallback:

When 5GC does not support emergency services, voice services, for load balancing, etc., inter-system fallback towards E-UTRAN is performed. Depending on factors such as CN interface availability, network configuration and radio conditions, the fallback procedure results in either RRC CONNECTED state mobility (e.g., handover procedure) or RRC IDLE state mobility (e.g., redirection).

For another example of E-UTRAN connected to EPC System fallback, when 5GC does not support emergency services, the UE and 5GC may support the mechanism to direct or redirect the UE towards EPS.

When the 5GS does not indicate the support for emergency services but indicates the support for emergency services fallback, the emergency services fallback mechanism can be applied. A normally registered UE supporting emergency services fallback may initiate a Service Request with Service Type set to Emergency Services fallback if the UE receives the Registration Accept message including the emergency services fallback via the serving cell from the serving AMF. Upon receiving the Service Request, the serving AMF may use the Service Type Indication within the Service Request to redirect the UE towards the appropriate RAT or core network system that support emergency services. The 5GS including the AMF may trigger handover or redirection to EPS, or handover or redirection to E-UTRA connected to 5GC, for emergency services. After receiving the Serve Request for Emergency Fallback, the serving AMF may trigger a procedure resulting in either handover procedure or redirection to either E-UTRA connected to 5GC or to E-UTRAN in EPC.

In the NG-C signalling procedure, the AMF based on support for emergency services, voice service, any other services or for load balancing, etc., may indicate the target CN type as EPC or 5GC to the gNB node. When the target CN type is received by gNB, the target CN type is also conveyed to the UE in RRCRelease Message. Upon receiving the RRC Release message including the target CN type, the UE may perform the redirection procedure to the target CN indicated by the target CN type.

The UE would set the RRC establishment cause to ‘emergency’ when the UE requests an RRC connection associated to an emergency session.

The UE would set the RRC resume cause to ‘emergency’ and select ‘2’ as the Access Category when the resumption of the RRC connected is triggered (e.g., due to an RNA update) and when the emergency service is ongoing.

When a PLMN supports IMS and emergency services, all AMFs in that PLMN may have the capability to support emergency services, and at least one SMF may have the capability to support emergency services.

It should be noticed that, currently, the SNPN does not support emergency services and eCall over IMS. The SNPN does not support the limited service state, so that a UE in SNPN network cannot enter limited service state to obtain the emergency services and eCall over IMS. In addition, it is E-UTRAN connected to 5GC rather than NR connected to 5GC that supports eCall over IMS. However, it is desired to support emergency services and eCall over IMS in SNPN and NR connected to 5GC.

In this disclosure, a method is proposed for the support of emergency services and eCall over IMS in SNPN. This method can be applicable for a UE in SNPN Access Mode (AM), no matter the UE camps normally on a suitable cell or not. This method can be further applicable for a UE not in SNPN AM, for any cell (e.g., an acceptable cell, a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, an SNPN cell for the UE to perform UE onboarding, an SNPN cell operated by the SNPN allowing registration attempts from UEs that are not explicitly configured to select the SNPN). The method may cover the Access Stratum (AS) signaling, Non-Access Stratum (NAS) signaling, the interaction between the UE and the cell, and the interaction between the UE and the core network.

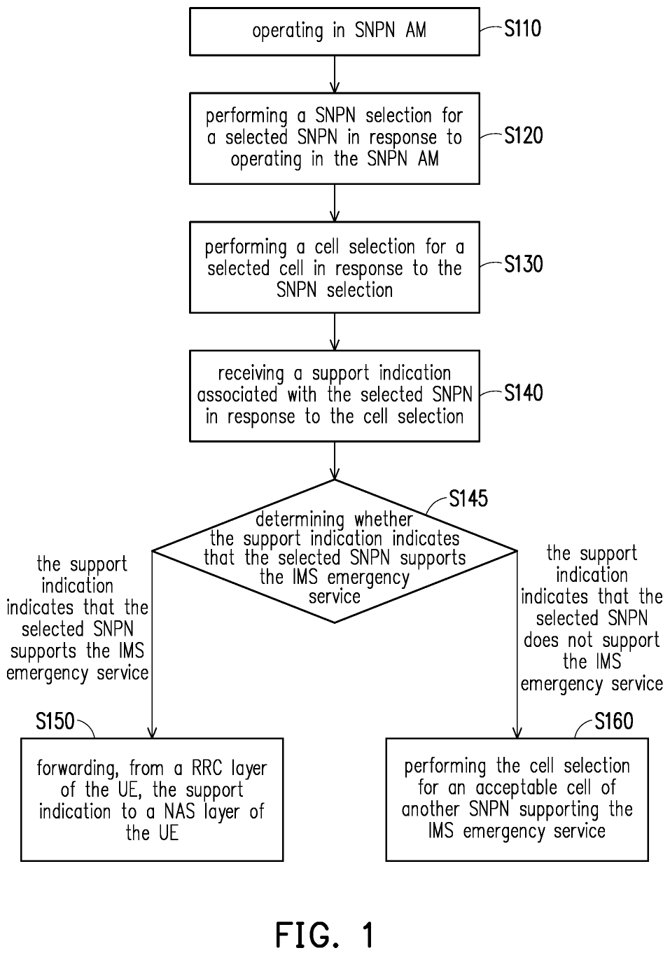

FIG. 1 is a flow chart that illustrates a method related to emergency service according to one of the exemplary embodiments of the disclosure. Referring to FIG. 1, note that the order of the steps in this Figure may be changed according to the actual requirements.

Step S110: a UE operates in SNPN AM. Specifically, SNPN Access Mode is a Mode of operation wherein UE only selects SNPNs. An SNPN-enabled UE supports the SNPN AM. When a UE is set to operate in SNPN access mode, the UE operating in SNPN AM may only select and register with SNPNs. In other words, the UE may be operating in SNPN AM, may camp on or be served by a cell that is operating by an SNPN.

Step S120: the UE performs a SNPN selection for a selected SNPN in response to operating in the SNPN AM. Specifically, there are two SNPN selection modes: automatic SNPN selection mode and manual SNPN selection mode. For example, the UE may select an SNPN, if available, allowable, and identified by an SNPN identity in an entry of the “list of subscriber data” (e.g., a subscriber identifier, a credential, or an SNPN identity) automatically or in response to a selection of the user operation. The UE may perform registration on the SNPN if the UE is capable of services which require registration. The UE successfully registers on an SNPN if: a) the UE has found a suitable cell of the SNPN to camp on; and b) an location registration (LR) request from the UE has been accepted in the registration area of the cell on which the UE is camped.

Step S130: the UE performs a cell selection for a selected cell in response to the SNPN selection. In one embodiment, the selected SNPN operates the selected cell. Specifically, a UE operating in SNPN AM may only select cells and networks broadcasting both PLMN ID and MD of the selected SNPN. In another embodiment, another network (e.g., SNPN or PLMN) different from the selected SNPN operates the selected cell.

In one embodiment, the UE may perform a cell reselection for a selected cell in response to the SNPN selection.

Step S140: the UE receives a support indication associated with the selected SNPN in response to the cell selection. The support indication indicates whether the selected SNPN supports IMS emergency service.

In one embodiment, the support indication may be an IMS emergency call support indication (e.g., ims-EmergencySupport) included in system information (e.g., SIB1) received from a cell that the UE camps on. In one embodiment, the support indication may be an eCall over IMS support indication included in system information (e.g., SIB1) from a cell that the UE camps on or connects to determine whether the cell and/or the network supports eCall over IMS. In one embodiment, the support indication may be both the IMS emergency call support indication and the eCall over IMS support indication. In one embodiment, the support indication may be an Emergency Service Support indicator included in a NAS message (e.g., Registration Accept message). In still another embodiment, the support indication could be another indication relating to the support of the emergency service.

In one embodiment, the support indication may be in the format of ENUMERATED {support}, ENUMERATED {support, not support}, ENUMERATED {true} or ENUMERATED {true, not true}.

Step S145: the UE determines whether the support indication indicates that the selected SNPN supports the IMS emergency service.

Step S150: the UE forwards, from a RRC layer of the UE, the support indication to a NAS layer of the UE when the support indication indicates that the selected SNPN supports the IMS emergency service. For example, if the support indication is set to “true”, the RRC layer of the UE forwards the support indication to the NAS layer of the UE.

Step S160: the UE performs the cell selection for an acceptable cell of another SNPN supporting the IMS emergency service when the support indication indicates that the selected SNPN does not support the IMS emergency service. For example, if the support indication is set to “not true” or is absent, the UE may attempt to camp on an acceptable cell of any available SNPN supporting emergency calls.

In the following, multiple scenarios based on the proposed method would be introduced.

In one embodiment, in one or more scenarios, a UE may determine to be in SNPN AM or not in SNPN AM based on (pre)configuration. Alternatively, a UE may be configured to be in SNPN AM or not in SNPN AM by the NAS layer of the UE or by the network. In the following embodiments, it is assumed that in the scenarios the UE is in SNPN AM.

A UE in SNPN AM may perform SNPN selection for a selected SNPN and cell (re)selection for a cell supporting SNPN. The NAS layer of the UE may determine the selected SNPN, and forward the information of the selected SNPN to the AS layer of the UE. The AS layer of the UE may perform measurement and evaluate the cell selection criteria (e.g., S criteria) and cell reselection criteria (e.g., R criteria). That is, a SNPN AM UE (i.e., the UE in SNPN mode) may end up (1) camping normally on a suitable cell supporting SNPN, and (2) not camping normally on a suitable cell supporting SNPN.

To support emergency services and eCall over IMS in SNPN for a UE in SNPN AM and for a cell supporting SNPN, the proposed method would address the following scenarios:
(1) A UE in SNPN AM camps normally on a suitable cell supporting SNPN. A UE in SNPN AM is in normal service state. For example, the selected cell from the cell selection is the suitable cell supporting SNPN.
(2) A UE in SNPN AM cannot camp normally on a suitable cell supporting SNPN. For example, the selected cell from the cell selection is not the suitable cell supporting SNPN. Alternatively, the selected cell is an acceptable cell. Scenario (2) may further include:
(a) A UE in SNPN AM is not in normal service state but in limited service state.
(b) A UE in SNPN AM is neither in normal service state nor in limited service state.

Scenario (1)(a): A UE in SNPN AM in normal service state:

In one embodiment, when the UE in SNPN AM in normal service state performs Registration procedure and/or Tracking Area Update procedure with the core network (i.e., 5GC supporting SNPN), the UE may receive an Emergency Service Support indicator (i.e., the support indication) in a NAS message (e.g., Registration Accept message) via the serving cell from the core network (e.g., the serving AMF). In one embodiment, if the SNPN supports emergency services, the core network (especially the AMF) may transmit the NAS message to the UE via a serving cell. The UE may determine whether the core network supports emergency services based on the Emergency Service Support indicator.

In one embodiment, the Emergency Service Support indicator may be specific to SNPN. That is, there are separate Emergency Service Support indicators, one for PLMN as legacy, and another one for SNPN as proposed. The UE in SNPN AM may receive the Emergency Service Support indicator specific to SNPN.

In one embodiment, the Emergency Service Support indicator may be common for PLMN and for SNPN. That is, if the AMF supporting PLMN and SNPN supports emergency services for PLMN and SNPN, the AMF may transmit the common Emergency Service Support indicator to the UE via a serving cell. In other words, the UE in SNPN AM may receive the legacy Emergency Service Support indicator for PLMN.

In one embodiment, when the UE in SNPN AM reads the system information (e.g., SIB1), the UE may receive an eCall over IMS support indication in the system information from the serving cell. Based on the eCall over IMS support indication, the UE may determine whether the cell and/or the network supports eCall over IMS. In one embodiment, the eCall over IMS support indication may be in the format of ENUMERATED{support}, ENUMERATED {support, not support}, ENUMERATED {true} or ENUMERATED {true, not true}. If the eCall over IMS support indication is “true” or “support”, the UE may determine that the cell (e.g., the selected cell from the cell selection) and/or the network (e.g., the selected SNPN from the SNPN selection) supports eCall over IMS. If the eCall over IMS support indication is absent or “not true” or “not support”, the UE may determine that the cell and/or the network does not support eCall over IMS.

In one embodiment, the eCall over IMS support indication may be specific to SNPN. If the SNPN in a non-shared environment or all SNPNs in a shared environment supports eCall over IMS, the serving cell may set the eCall over IMS support indication to “true” or “support”. The UE in SNPN AM may determine whether the cell supports eCall over IMS based on the eCall over IMS support indication specific to SNPN, and ignore the legacy eCall over IMS support indication for PLMN if received.

In one embodiment, the eCall over IMS support indication may be specific to per SNPN. For each SNPN operating the serving cell, the serving cell may set or transmit an eCall over IMS support indication associated to each SNPN. If a specific SNPN supports eCall over IMS, the serving cell may set the eCall over IMS support indication to “true” or “support”. The UE in SNPN AM may determine whether the cell supports eCall over IMS based on the eCall over IMS support indication associated to the UE's selected or registered SNPN. In one embodiment, the UE in SNPN AM may ignore the eCall over IMS support indication not associated to the UE's selected or registered SNPN.

In one embodiment, the eCall over IMS support indication may be common for PLMN and SNPN. For all PLMNs and SNPNs operating the serving cell, the serving cell may set or transmit an eCall over IMS support indication common to all networks (e.g., PLMN, SNPN) operating the cell.

If all networks operating the cell or at least one network operating the cell support the eCall over IMS, the serving cell may set the common eCall over IMS support indication to “true” or “support” to UEs via system information (e.g., SIB1). The UE in SNPN AM may determine whether the cell supports eCall over IMS based on the common eCall over IMS support indication.

In some embodiments, a UE in normal service state may receive both the eCall over IMS support indication carried in system information (e.g., SIB1) and the Emergency Service Support indicator carried in a NAS message in a Registration procedure and/or Tracking Area Update procedure. In other words, the UE in normal service state may receive system information (e.g., SIB1) including the eCall over IMS support indication and receive a NAS message including the Emergency Service Support indiction in a Registration procedure and/or Tracking Area Update procedure.

In one embodiment, upon (the RRC layer of) the UE receiving the eCall over IMS support indication associated to the UE's selected or registered SNPN or associated to SNPN or common eCall over IMS support indication if present, (the RRC layer of) the UE may forward the eCall over IMS support indication associated to the UE's selected or registered SNPN or associated to SNPN or the common eCall over IMS support indication if present to the upper layers of the UE (e.g., the NAS layer of the UE).

In one embodiment, a UE may transmit an RRC message having a RRC establishment cause or a RRC resume cause which is set as emergency'. For example, the UE in SNPN AM in normal service state may set the RRC establishment cause to ‘emergency’ in RRC establishment request message when the UE requests an RRC connection associated to an emergency session for SNPN, e.g., by transmitting the RRC (connection) setup request message (or the RRC reestablishment request message) to the cell supporting the emergency services for SNPN.

For another example, the UE in SNPN AM and in normal service state may set the RRC resume cause to ‘emergency’ and select ‘2’ as the Access Category in RRC (connection) resume request message when the resumption of the RRC connected is triggered (e.g., due to an RNA update) and when the emergency service for SNPN is ongoing. Afterwards, the RRC (connection) resume request message indicated with the RRC resume cause to emergency' would be transmitted. In other words, the RRC layer of the UE may forward the RRC (connection) resume request message including the RRC resume cause to ‘emergency’ to the lower layers of the UE (e.g., MAC layer of the UE) for transmission.

Scenario (2)(a): A UE in SNPN AM in limited service state:

In one embodiment, in this scenario, a UE in SNPN AM that cannot find a suitable cell during cell (re)selection may enter the limited service state. In limited service state, the UE may have at least one of the emergency services, ETWS and CMAS from a cell. Such cell may be an acceptable cell, a cell operated by SNPN, and/or a cell (only) operated by PLMN. The minimum requirements for such cell is that the cell is not barred and the cell selection criteria are fulfilled. Such limited service state is applicable for a UE in SNPN AM, which may be different from the legacy limited service state for a UE not in SNPN AM. In one embodiment, such limited service state for a UE in SNPN AM may be the same as the legacy limited service state for a UE not in SNPN AM.

In one embodiment, a cell broadcasting at least one SNPN identity may be determined to be a cell operated by SNPN. A cell broadcasting at least one PLMN identity may be determined to be a cell operated by PLMN. A cell broadcasting only PLMN identities and no NPN identities may be determined to be a cell operated (only) by PLMN.

In one embodiment, when the UE in SNPN AM and in limited service state camps on a cell (e.g., an acceptable cell, a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, or an SNPN cell for the UE to perform UE onboarding), the UE may determine whether the cell supports emergency services based on the IMS emergency call support indication (e.g., ims-EmergencySupport) included in system information (e.g., SIB1) received from a cell that the UE camps on. In one embodiment, the IMS emergency call support indication may be in the format of ENUMERATED {support}, ENUMERATED {support, not support}, ENUMERATED {true} or ENUMERATED {true, not true} . If the IMS emergency call support indication is set to “true” or “support”, the UE may determine that the cell (e.g., the selected cell from the cell selection) supports IMS emergency call. If the IMS emergency call support indication is absent or is set to “not true” or “not support”, the UE may determine that the cell (e.g., the selected cell from the cell selection) and/or the SNPN (the selected SNPN from the SNPN selection) does not support IMS emergency call.

In one embodiment, the IMS emergency call support indication may be specific for SNPN. For example, the cell may set the IMS emergency call support indication to “true” or “support” if any AMF supporting SNPN in a non-shared environment or at least one of SNPNs in a shared environment supports IMS emergency bearer service. The UE in SNPN AM may determine whether the cell supports IMS emergency call based on the IMS emergency call support indication specific for SNPN. In one embodiement, the UE in SNPN AM may ignore the legacy IMS emergency call support indication for PLMN if received.

In one embodiment, the IMS emergency call support indication may be specific to per SNPN (and/or per PLMN). For each network (e.g., PLMN, SNPN) operating the camped cell, the camped cell may set or transmit the IMS emergency call support indication associated to each network. If a specific network supports the IMS emergency call, the cell may transmit the IMS emergency call support indication associated to the specific network set to “true” or “support”. If a specific network does not support the IMS emergency call, the cell may not transmit the IMS emergency call support indication associated to the specific network (for example, the IMS emergency call support indication is absent), or the cell may transmit the IMS emergency call support indication associated to the specific network set to “not true” or “not support”. The UE in SNPN AM may determine whether the cell supports IMS emergency call based on the IMS emergency call support indication associated to the UE's selected SNPN from the SNPN selection. In one embodiment, the UE in SNPN AM may ignore the IMS emergency call support indication not associated to the UE's selected SNPN.

In one embodiment, the IMS emergency call support indication may be common for PLMN and SNPN. For all PLMNs and SNPN operating the camped cell, the camped cell may set or transmit the IMS emergency call support indication common to all networks (e.g., PLMN, SNPN) operating the cell. If all networks operating the cell or at least one network operating the cell support the IMS emergency call, the camped cell may set the common IMS emergency call support indication to “true” or “support” and transmit to UEs via system information (e.g., SIB1). In one embodiment, the UE in SNPN AM may determine whether the cell supports IMS emergency call based on the common IMS emergency call support indication.

In one embodiment, upon (the RRC layer of) the UE receiving the IMS emergency call support indication associated to the UE's selected SNPN or associated to SNPN or common IMS emergency call support indication if present, (the RRC layer of) the UE may forward the IMS emergency call support indication associated to the UE's selected SNPN or associated to SNPN or the common IMS emergency call support indication if present to the upper layers of the UE (e.g., the NAS layer of the UE).

In one embodiment, when the UE in SNPN AM and in limited service state camps on a cell (e.g., an acceptable cell, a cell broadcasting at least one SNPN identity, a cell broadcasting at least one PLMN identity, or a cell broadcasting only PLMN identities and no NPN identities), the UE may determine whether the cell (e.g., the cell where the UE receives the broadcasted information, the selected cell from the cell (re)selection) and/or the network (e.g., the network that operates the cell where the UE receives the broadcasted information, the selected SNPN from the SNPN selection) via the cell supporting eCall over IMS based on the IMS emergency call support indication (e.g., ims-EmergencySupport) and/or the eCall over IMS support indication (e.g., eCallOverIMS-Support) included in system information (e.g., SIB1) received from a cell that the UE camps on. In one embodiment, the eCall over IMS support indication may be in the format of ENUMERATED {support}, ENUMERATED {support, not support}, ENUMERATED {true} or ENUMERATED {true, not true}. If the eCall over IMS support indication is set to “true” or “support”, the UE may determine that the selected cell supports eCall over IMS. If the eCall over IMS support indication is absent or is set to “not true” or “not support”, the UE may determine that the cell (or the selected cell) and/or the SNPN (or the selected SNPN) does not support eCall over IMS. Alternatively, if the IMS emergency call support indication is set to “true” or “support” and the eCall over IMS support indication is set to “true” or “spport”, the UE may determine that the cell supports eCall over IMS. If the eCall over IMS support indication is absent or is set to “not true” or “not support” or if the IMS emergency call support indication is absent or set to “not true” or “not support”, the UE may determine that the cell does not support eCall over IMS.

In one embodiment, the eCall over IMS support indication may be specific for SNPN. The cell may set the eCall over IMS support indication to “true” or “support” if any AMF supporting SNPN in a non-shared environment, the SNPN in a non-shared environment, at least one of SNPNs in a shared environment, or all SNPNs in a shared environment supports eCall over IMS. The UE in SNPN AM may determine whether the cell supports eCall over IMS based on the eCall over IMS support indication specific for SNPN and/or the IMS emergency call support indication (e.g., specific for SNPN, specific to per SNPN (and/or per PLMN), or common for PLMN and SNPN). In one embodiment, the UE in SNPN AM may ignore the legacy eCall over IMS support indication for PLMN if received.

In one embodiment, the eCall over IMS support indication may be specific to per SNPN (and/or per PLMN). For each network (e.g., PLMN, SNPN) operating the camped cell, the camped cell may set or transmit the eCall over IMS support indication associated to each network. If a specific network supports the eCall over IMS, the cell may transmit the eCall over IMS support indication associated to the specific network set to “true” or “support” and/or the IMS emergency call support indication (e.g., specific for SNPN, specific to per SNPN (and/or per PLMN), common for PLMN and SNPN) set to “true” or “support”. If a specific network does not support the eCall over IMS, the cell may not transmit the eCall over IMS support indication associated to the specific network, the cell may not transmit the eCall over IMS support indication associated to the specific network and may transmit the IMS emergency call supporting indication (e.g., specific for SNPN, specific to per SNPN (and/or per PLMN), common for PLMN and SNPN) set to “not true” or “not support”, the cell may neither transmit the eCall over IMS support indication associated to the specific network and nor transmit the IMS emergency call support indication (e.g., specific for SNPN, specific to per SNPN (and/or per PLMN), or common for PLMN and SNPN), the cell may transmit the eCall over IMS support indication associated to the specific network set to “not true” or “not support”, the cell may transmit the eCall over IMS support indication associated to the specific network set to “not true” or “not support” and the cell may not transmit the IMS emergency call support indication (e.g., specific for SNPN, specific to per SNPN (and/or per PLMN), common for PLMN and SNPN), or the cell may transmit the eCall over IMS support indication associated to the specific network set to “not true” or “not support” and the cell may transmit the IMS emergency call support indication (e.g., specific for SNPN, specific to per SNPN (and/or per PLMN), common for PLMN and SNPN) set to “not true” or “not support”. The UE in SNPN AM may determine whether the cell supports eCall over IMS based on the eCall over IMS support indication associated to the UE's selected SNPN. In one embodiment, the UE in SNPN AM may ignore the eCall over IMS support indication not associated to the UE's selected SNPN.

In one embodiment, the eCall over IMS support indication may be common for PLMN and SNPN. For all PLMNs and SNPN operating the camped cell, the camped cell may set or transmit the eCall over IMS support indication common to all networks (e.g., PLMN, SNPN) operating the cell. If all networks operating the cell or at least one network operating the cell support the eCall over IMS, the camped cell may set the common eCall over IMS support indication to “true” or “support” and transmit to UEs via system information (e.g., SIB1), or the camped cell may transmit the common eCall over IMS support indication set to “true” or “support” and the IMS emergency call support indication (e.g., specific for SNPN, specific to per SNPN (and/or per PLMN), common for PLMN and SNPN) set to “true” or “support” to UEs via system information (e.g., SIB1). If all networks operating the cell or at least one network operating the cell does not support the eCall over IMS, the camped cell may set the common eCall over IMS support indication to “not true” or “not support” and transmit to UEs via system information (e.g., SIB1), the camped cell may transmit the common eCall over IMS support indication set to “not true” or “not support” and the IMS emergency call support indication (e.g., specific for SNPN, specific to per SNPN (and/or per PLMN), common for PLMN and SNPN) set to “not true” or “not support” to UEs via system information (e.g., SIB1), the camped cell may neither transmit the common eCall over IMS support indication and nor transmit the IMS emergency call support indication (e.g., specific for SNPN, specific to per SNPN (and/or per PLMN), or common for PLMN and SNPN) to UEs via system information (e.g., SIB1). The UE in SNPN AM may determine whether the cell supports eCall over IMS based on the common eCall over IMS support indication and/or the IMS emergency call support indication (e.g., specific for SNPN, specific to per SNPN (and/or per PLMN), or common for PLMN and SNPN).

In one embodiment, upon (the RRC layer of) the UE receiving the eCall over IMS support indication associated to the UE's selected SNPN or associated to SNPN or common eCall over IMS support indication if present and/or receiving the IMS emergency call support indication (e.g., specific for SNPN, specific to per SNPN (and/or per PLMN), or common for PLMN and SNPN), (the RRC layer of) the UE may forward the eCall over IMS support indication associated to the UE's selected SNPN or associated to SNPN or the common eCall over IMS support indication and/or IMS emergency call support indication (e.g., specific for SNPN, specific to per SNPN (and/or per PLMN), or common for PLMN and SNPN) if present to the upper layers of the UE (e.g., the NAS layer of the UE).

Scenario (2)(b): A UE in SNPN AM neither in normal service state nor in limited service state:

In one embodiment, in this scenario, a UE in SNPN AM neither in normal service state nor in limited service state may still be provided with the emergency services and/or the eCall over IMS based on the IMS emergency call supporting indication and/or the eCall over IMS support indication.

In one embodiment, when the UE in SNPN AM camps on a cell (e.g., an acceptable cell, a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, or an SNPN cell for the UE to perform UE onboarding) or when the UE in SNPN can receive the synchronization signal and/or system information (e.g., MIB, SIB1) from a cell (e.g., a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, or an SNPN cell for the UE to perform UE onboarding), the UE may determine whether the cell supports emergency services based on the IMS emergency call support indication (e.g., ims-EmergencySupport) included in system information (e.g., SIB1) received from the cell, and/or the UE may determine whether the cell supports eCall over IMS based on the eCall over IMS support indication (e.g., eCallOverIMS-Support) and/or the IMS emergency call support indication included in system information (e.g., SIB1) received from the cell.

In one embodiment, the design of the IMS emergency call support indication and the eCall over IMS support indication such as the format of these indications, the conditions and corresponding cell behaviors, the conditions and corresponding UE behaviors in Scenario (2)(a) may be applicable for Scenario (2)(b).

System design for emergency services in SNPN:

In one embodiment, for emergency services over 3GPP access, other than eCall over IMS, a UE in SNPN AM, no matter in limited service state or not, may determine that the cell supports emergency services over NR-RAN based on the broadcast IMS emergency call support indication.

In one embodiment, depending on local regulation, receiving emergency services for a UE in SNPN AM, no matter in limited service state or not, may not require a valid subscription and/or may not require the SNPN operating the cell from which the UE receives the IMS emergency call support indication and/or the eCall over IMS support indication owns the UE's (NPN) credentials.

In one embodiment, depending on local regulation and operator's policy, the network may allow or reject a registration request for emergency services (e.g., emergency registration) from a UE in SNPN AM, no matter in limited service state or not.

In one embodiment, emergency calls for eCall over IMS may be supported over NR (e.g., a NR cell operated by SNPN, or a NR cell operated by PLMN). The UE may originate the emergency calls for eCall over IMS over NR.

In one embodiment, the proposed method may be applicable for a UE in SNPN AM and configured for eCall Only Mode.

In one embodiment, any cell that supports the transmission of the IMS emergency call support indication and/or the eCall over IMS support indication may be connected to the serving AMF in the 5GC. The serving AMF is configurd with Emergency Configuration Data that are applied to emergency services. The emergency services are established by the serving AMF based on the request from the UE in SNPN AM. The AMF Emergency Configuration Data may include the S-NSSAI (specific to SNPN) and Emergency DNN (specific to SNPN) which is used to derive an SMF.

In one embodiment, the UE in SNPN AM and in normal service state (e.g., Scenario (1)(a)) may apply Registration procedure to get the emergency services. In one embodiment, the UE in SNPN AM may receive the Registration Accept message including an Emergency Service Support indicator (specific to SNPN) from the AMF in 5GC via a serving cell. The serving cell may be a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, an SNPN cell for the UE to perform UE onboarding, etc. In one embodiment, the Emergency Service Support indicator is valid within the current Registration Area per RAT. In one embodiment, after receiving the Emergency Service Support indicator, the UE in SNPN AM in normal service state may setup emergency PDU session to obtain emergency services. The serving AMF may transmit the Registration Accept message including Emergency Service Support to the UE if any of the following conditions happens:

The SNPN operating the AMF supports emergency services over 5GS (5G system);

E-UTRA connected to 5GC supports IMS emergency services (e.g., voice), and the NG-RAN operated by SNPN can trigger handover or redirection from NR in SNPN to E-UTRA connected to 5GC, e.g., at QoS Flow establishment for IMS emergency services;

NG-RAN operated by SNPN can trigger handover to EPS, e.g., at QoS Flow establishment for IMS emergency services; or

NG-RAN operated by SNPN can trigger redirection to EPS, e.g., at QoS Flow establishment for IMS emergency services.

In one embodiment, the UE in SNPN AM in normal service state may be informed that the SNPN (e.g., the selected or registered SNPN) supports Emergency Services over 5G from the Emergency Service Support indicator in the Registration procedure.

In one embodiment, the UE in SNPN AM, no matter in limited service state or not (e.g., Scenario (2)(a) and Scenario (2)(b)), or the UE in SNPN AM failing to register successfully to the network, may apply Emergency Registration procedure to get the emergency services. During the Emergency Registration, the UE may transmit a Registration Request message including a Follow-on request to initiate PDU Session Establishment procedure with a Request Type indicating “Emergency Request”.

In one embodiment, the UE in SNPN AM in normal service state, or the UE in SNPN AM no matter in limited service state, may support emergency services fallback, e.g., RAT fallback and Inter-System fallback. The 5GC may transmit an indication (e.g., the support for emergency services fallback indicator) per RAT indicating whether the 5GC supports emergency service fallback to another RAT in 5GS or to another system supporting emergency services.

For example, the UE in SNPN AM may perform RAT fallback towards E-UTRAN connected to 5GC for emergency services. It may result in that the UE switches from operating in SNPN AM to not operating in SNPN AM.

For example, the UE in SNPN AM may perform inter-system fallback towards to E-UTRAN connected to EPC for emergency services. It may result in that the UE switches from operating in SNPN AM to not operating in SNPN AM.

For example, the UE in SNPN AM may receive an RRC message (e.g., RRC Release message) indicating the target CN type (e.g., EPC or 5GC) for the UE to fallback to.

In one embodiment, a UE supporting SNPN AM only (i.e., the UE does not support the switch to not operating in SNPN AM), may not support RAT fallback and inter-system fallback, even if the UE receives the indication indicating the 5GC supports emergency fallback.

In one embodiment, when the 5GS does not indicate the support for emergency services but indicates the support for emergency services fallback, the emergency services fallback mechanism for the UE in SNPN AM may be applied.

In one embodiment, when a SNPN supports IMS and emergency services, all AMFs in that SNPN or at least one AMF in that SNPN may have the capability to support emergency services, and at least one SMF may have the capability to support emergency services.

In one embodiment, when the UE in SNPN AM (e.g., in Scenario (1), Scenario(2)(a), or Scenario(2)(b)) supports voice services, emergency services, and/or eCall over IMS, and the UE finds that the current cell from which the UE receives indicators (e.g., as proposed support indications in Scenario (1), Scenario(2)(a), or Scenario(2)(b)) does not support IMS emergency calls and/or eCall over IMS, the UE may continue to perform cell (re)selection for a cell (e.g., a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, or an SNPN cell for the UE to perform UE onboarding) that supports emergency services and/or eCall over IMS in any supported RAT, regardless of priorities provided in system information from current cell, if no suitable cell is found. For example, if the UE supports voice services, the UE is in SNPN access mode, and the current cell does not support IMS emergency calls for any SNPN(s) as indicated by the field imsEmergencySupportFor SNPN in SIB1, the UE may perform cell (re)selection to an acceptable cell of any available SNPN that supports emergency calls, if no suitable cell is found.

In one embodiment, for Emergency Services over NR via SNPN, other than eCall over IMS, the UE in limited service state that operates in SNPN AM may determine that the cell supports Emergency Services over NR from a broadcast indicator in AS and a support indication that the SNPN supports Emergency Services. If the UE operates in SNPN access mode and is in limited service state, the UE may attempt to camp on an acceptable cell of any available SNPN supporting emergency calls (irrespective of SNPN ID or Group ID (GIN)). In one embodiment, if the UE cannot find an acceptable cell on any available SNPN, for example, any acceptable cell of a SNPN is absent from the cell (re)selection, the UE may deactivate SNPN AM and camp on any available PLMN cell supporting emergency calls.

Designs for a legacy UE and for a UE not in SNPN AM:

In one embodiment, a legacy UE including a UE in SNPN AM not supporting emergency services (e.g., Rel-16 SNPN does not support emergency services and eCall over IMS) and a UE not in SNPN AM (e.g., a legacy or advanced UE not in SNPN AM) may ignore the proposed indicators (e.g., the IMS emergency call support indication, the eCall over IMS support indication, or the Emergency Service Support indicator) for enabling emergency services and/or eCall over IMS in SNPN, if received.

In another embodiment, an advanced UE not in SNPN AM may follow the proposed method to obtain the emergency services via a cell (e.g., a cell broadcasting at least one SNPN identity, a cell broadcasting at least one PLMN identity, a cell broadcasting only PLMN identities and no NPN identities, a NR cell connected to 5GC, an SNPN cell where the SNPN operating the cell does not own the UE's (NPN) credential, or an SNPN cell for the UE to perform UE onboarding). It enables the advanced UE not in SNPN AM can obtain the emergency services and/or eCall over IMS from SNPN or specific for SNPN.

Designs for a UE with credentials from a separate entity and/or for a UE that is not explicitly configured to select a SNPN:

Case 1: whether access using credentials from a separate entity is supported.

In one embodiment, when a UE (e.g., a UE with credentials from a separate entity (a credential holder) other than a SNPN) receives a SIB1 including an indication, indicating that access using credentials from a separate entity (a credential holder) is not supported, from a cell operating by the SNPN, or when the UE receives a SIB1 excluding the indication (i.e., the indication is absent), indicating whether access using credentials from a separate entity (a credential holder) is supported, from a cell operated by the SNPN, the UE
(1) may ignore the eCall over IMS support indication if received from the cell,
(2) may ignore the IMS emergency call support indication if received from the cell,
(3) may ignore the Emergency Service Support indicator if received from the serving AMF via the cell,
(4) may not obtain the IMS emergency service from this cell,
(5) may not obtain the eCall over IMS service from this cell,
(6) may not obtain the IMS emergency service from this cell even if the cell indicates that it supports IMS emergency service (e.g., by broadcasting IMS emergency call support indication),
(7) may not obtain the IMS emergency service from this cell even if the serving AMF connected to this cell transmits a NAS message (e.g., Registration Accept message) including the Emergency Service Support indicator via this cell to the UE, and/or
(8) may not obtain the eCall over IMS even if the cell indicates that it supports eCall over IMS (e.g., by broadcasting the IMS emergency call support indication set to “true” and the eCall over IMS support indication set to “true”, by broadcasting the eCall over IMS support indication set to “true”).

In one embodiment, when a UE (e.g., a UE with credentials from a separate entity (a credential holder) other than a SNPN) receives a SIB1 including an indication, indicating that access using credentials from a separate entity (a credential holder) is supported, from a cell operating by the SNPN, or when a UE (e.g., a UE with credentials from a separate entity (a credential holder) other than a SNPN) receives a SIB1 including an indication, indicating that access using credentials from a separate entity (a credential holder) is not supported, from a cell operating by the SNPN, or when the UE receives a SIB1 excluding the indication (i.e., the indication is absent), indicating whether access using credentials from a separate entity (a credential holder) is supported, from a cell operated by the SNPN, the UE may have at least one of the following two behaviors (1) and (2).

(1) The UE may behave like the designs for Scenario (2)(a) and Scenario (2)(b) but further consider the indication indicating whether access using credentials from a separate entity (a credential holder) is supported, or for example, the UE may obtain the eCall over IMS via this cell if this cell broadcasts the eCall over IMS support indication set to “true” or “support” and this cell broadcasts the IMS emergency call support indication set to “true” or “support”, or for example, the UE may not obtain the eCall over IMS via this cell if this cell does not broadcast the eCall over IMS support indication, if this cell does not broadcast the IMS emergency call support indication, or if this cell broadcasts at least one of the eCall over SIM support indication and the IMS emergency call support indication set to “not true” or “not support”, or for example, the UE may obtain the IMS emergency services via this cell if this cell broadcasts the IMS emergency support indication set to “true” or “support”, or for example, the UE may not obtain the IMS emergency services via this cell if this cell broadcasts the IMS emergency support indication set to “not true” or “not support” or if this cell does not broadcast the IMS emergency support indication.

(2) The UE may behave like the designs for Scenario (1) but further consider the indication indicating whether access using credentials from a separate entity (a credential holder) is supported.

For example, the UE may obtain the IMS emergency services via this cell if the serving AMF connected to this cell transmits a NAS message (e.g., Registration Accept message) including the Emergency Service Support Indication set to “true” or “support” to the UE via this cell, or for example, the UE may not obtain the IMS emergency services via this cell if the serving AMF connected to this cell transmits a NAS message (e.g., Registration Accept message) including the Emergency Service Support Indication set to “not true” or “not support” to the UE via this cell or if the serving AMF connected to this cell transmits a NAS message (e.g., Registration Accept message) excluding the Emergency Service Support Indication (i.e., the indication is absent).

For example, the UE may obtain the eCall over IMS via this cell if the cell broadcasts the eCall over IMS support indication set to “true” or “support”, or for example, the UE may not obtain the eCall over IMS via this cell if the cell does not broadcast the eCall over IMS support indication or if the cell broadcasts the eCall over IMS support indication set to “not true” or “not support”.

Case 2: whether the SNPN allows registration attempts from UEs that are not explicitly configured to select the SNPN.

In one embodiment, when the cell operated by an SNPN broadcasts a SIB1 including an indicator, indicating that the SNPN does not allow registration attempts from UEs that are not explicitly configured to select the SNPN, or when the cell operated by an SNPN broadcasts a SIB1 with the indicator, indicating whether the SNPN allows registration attempts from UEs that are not explicitly configured to select the SNPN, to be absent, the UE (e.g., the UE that is not explicitly configured to select the SNPN)
(1) may ignore the eCall over IMS support indication if received from the cell,
(2) may ignore the IMS emergency call support indication if received from the cell,
(3) may ignore the Emergency Service Support indicator if received from the serving AMF via the cell,
(4) may not obtain the IMS emergency service from this cell,
(5) may not obtain the eCall over IMS service from this cell,
(6) may not obtain the IMS emergency service from this cell even if the cell indicates that it supports IMS emergency service (e.g., by broadcasting IMS emergency call support indication),
(7) may not obtain the IMS emergency service from this cell even if the serving AMF connected to this cell transmits a NAS message (e.g., Registration Accept message) including the Emergency Service Support indicator via this cell to the UE, and/or
(8) may not obtain the eCall over IMS even if the cell indicates that it supports eCall over IMS (e.g., by broadcasting the IMS emergency call support indication set to “true” or “support” and the eCall over IMS support indication set to “true” or “support”, by broadcasting the eCall over IMS support indication set to “true” or “support”).

In one embodiment, when a UE (e.g., a UE that is not explicitly configured to select the SNPN) receives a SIB1 including an indication, indicating that the SNPN allows registration attempts from UEs that are not explicitly configured to select the SNPN, from a cell operating by the SNPN, or when a UE (e.g., a UE that is not explicitly configured to select the SNPN) receives a SIB1 including an indication, indicating that the SNPN does not allow registration attempts from UEs that are not explicitly configured to select the SNPN, from a cell operating by the SNPN, or when the UE receives a SIB1 excluding the indication (i.e., the indication is absent), indicating whether the SNPN allows registration attempts from UEs that are not explicitly configured to select the SNPN, from a cell operated by the SNPN, the UE may have at least one of the following two behaviors (1) and (2).

(1) The UE may behave like the designs for Scenario (2)(a) and Scenario (2)(b) but further consider the indication indicating whether the SNPN allows registration attempts from UEs that are not explicitly configured to select the SNPN, or

for example, the UE may obtain the eCall over IMS via this cell if this cell broadcasts the eCall over IMS support indication set to “true” or “support” and this cell broadcasts the IMS emergency call support indication set to “true” or “support”, or

for example, the UE may not obtain the eCall over IMS via this cell if this cell does not broadcast the eCall over IMS support indication, if this cell does not broadcast the IMS emergency call support indication, or if this cell broadcasts at least one of the eCall over SIM support indication and the IMS emergency call support indication set to “not true” or “not support”, or

for example, the UE may obtain the IMS emergency services via this cell if this cell broadcasts the IMS emergency support indication set to “true” or “support”, or

for example, the UE may not obtain the IMS emergency services via this cell if this cell broadcasts the IMS emergency support indication set to “not true” or “not support” or if this cell does not broadcast the IMS emergency support indication.

(2) The UE may behave like the designs for Scenario (1) but further consider the indication indicating whether the SNPN allows registration attempts from UEs that are not explicitly configured to select the SNPN.

For example, the UE may obtain the IMS emergency services via this cell if the serving AMF connected to this cell transmits a NAS message (e.g., Registration Accept message) including the Emergency Service Support Indication set to “true” or “support” to the UE via this cell, or

for example, the UE may not obtain the IMS emergency services via this cell if the serving AMF connected to this cell transmits a NAS message (e.g., Registration Accept message) including the Emergency Service Support Indication set to “not true” or “not support” to the UE via this cell or if the serving AMF connected to this cell transmits a NAS message (e.g., Registration Accept message) excluding the Emergency Service Support Indication (i.e., the indication is absent).

For example, the UE may obtain the eCall over IMS via this cell if the cell broadcasts the eCall over IMS support indication set to “true” or “support”, or

for example, the UE may not obtain the eCall over IMS via this cell if the cell does not broadcast the eCall over IMS support indication or if the cell broadcasts the eCall over IMS support indication set to “not true” or “not support”.

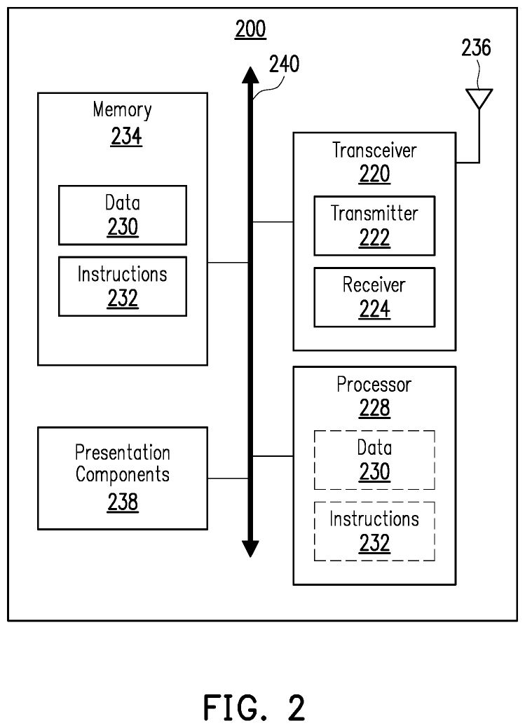

FIG. 2 illustrates a block diagram of a node for wireless communication, in accordance with various aspects of the present application. As shown in FIG. 2, a node 200 may include a transceiver 220, a processor 228, a memory 234, one or more presentation components 238, and at least one antenna 236. The node 200 may also include an RF spectrum band module, a base station communications module, a network communications module, and a system communications management module, Input/Output (I/O) ports, I/O components, and power supply (not explicitly shown in FIG. 2). Each of these components may be in communication with each other, directly or indirectly, over one or more buses 240. In one implementation, the node 200 may be a UE or a base station that performs various functions described herein, for example, with reference to FIG. 1.

The transceiver 220 having a transmitter 222 (e.g., transmitting/transmission circuitry) and a receiver 224 (e.g., receiving/reception circuitry) may be configured to transmit and/or receive time and/or frequency resource partitioning information. In some implementations, the transceiver 220 may be configured to transmit in different types of subframes and slots including, but not limited to, usable, non-usable and flexibly usable subframes and slot formats. The transceiver 220 may be configured to receive data and control channels.

The node 200 may include a variety of computer-readable media. Computer-readable media can be any available media that can be accessed by the node 200 and include both volatile and non-volatile media, removable and non-removable media. By way of example, and not limitation, computer-readable media may include computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not include a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 234 may include computer-storage media in the form of volatile and/or non-volatile memory. The memory 234 may be removable, non-removable, or a combination thereof. Exemplary memory includes solid-state memory, hard drives, optical-disc drives, and etc. As illustrated in FIG. 2, The memory 234 may store computer-readable, computer-executable instructions 232 (e.g., software codes) that are configured to, when executed, cause the processor 228 to perform various functions described herein, for example, with reference to FIGS. 1 through 2-1. Alternatively, the instructions 232 may not be directly executable by the processor 228 but be configured to cause the node 200 (e.g., when compiled and executed) to perform various functions described herein.

The processor 228 (e.g., having processing circuitry) may include an intelligent hardware device, e.g., a Central Processing Unit (CPU), a microcontroller, an ASIC, and etc. The processor 228 may include memory. The processor 228 may process the data 230 and the instructions 232 received from the memory 234, and information through the transceiver 220, the base band communications module, and/or the network communications module. The processor 228 may also process information to be sent to the transceiver 220 for transmission through the antenna 236, to the network communications module for transmission to a core network.

One or more presentation components 238 presents data indications to a person or other device. Exemplary presentation components 238 include a display device, speaker, printing component, vibrating component, and etc.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure

What is claimed is:

1. A method related to emergency service, used for a user equipment (UE), the method comprising:
operating in standalone non-public network (SNPN) access mode (AM);
performing a SNPN selection for a selected SNPN in response to operating in the SNPN AM;
performing a cell selection for a selected cell in response to the SNPN selection;
receiving a support indication associated with the selected SNPN in response to the cell selection, wherein the support indication indicates whether the selected SNPN supports IP multimedia subsystem (IMS) emergency service;
forwarding, from a radio resource control (RRC) layer of the UE, the support indication to a non-access stratum (NAS) layer of the UE when the support indication indicates that the selected SNPN supports the IMS emergency service; and
performing the cell selection for an acceptable cell of another SNPN supporting the IMS emergency service when the support indication indicates that the selected SNPN does not support the IMS emergency service.

2. The method of claim 1, wherein the support indication indicates whether the selected SNPN supports the IMS emergency service over a next-generation radio access network (NG-RAN).

3. The method of claim 1, wherein the selected SNPN operates the selected cell.

4. The method of claim 1, wherein the UE is operated in a normal service state for the selected cell, and the support indication is carried in at least one of a NAS message in a registration procedure or system information.

5. The method of claim 4, further comprising:
transmitting an RRC message having a RRC establishment cause or a RRC resume cause which is set as emergency.

6. The method of claim 1, wherein the UE is operated in a limited service state for the selected cell, and the support indication is carried in System Information Block 1 (SIB1).

7. The method of claim 6, wherein the UE is operated in the limited service when the UE cannot find a suitable during the cell selection, and the UE has at least one of emergency services, earthquake and tsunami warning system (ETWS), and commercial mobile alerting system (CMAS) from the selected cell.

8. The method of claim 1, further comprising:
determining that the selected SNPN does not support the IMS emergency service for the UE in a limited service state when the support indication indicating that the selected SNPN supports the IMS emergency service is absent.

9. The method of claim 1, further comprising:
deactivating the SNPM AM when the acceptable cell of the another SNPN is absent from the cell selection.

10. The method of claim 1, wherein perfroming the cell selection for the acceptable cell of the another SNPN supporting the IMS emergency service comprises:
performing the cell selection for the acceptable cell of the another SNPN supporting the IMS emergency service when the UE supports a voice service, the UE is operating in the SNPN AM, and the selected cell does not support the IMS emergency service for any SNPN indicated by the support indication.

11. A user equipment (UE), comprising:
a transceiver, used for transmitting or receiving signals;
a memory, used for storing a program code; and
a processor, coupled to the transceiver and the memory, configured to load and execute the program code to perform:
operating in standalone non-public network (SNPN) access mode (AM);
performing a SNPN selection for a selected SNPN in response to operating in the SNPN AM;
performing a cell selection for a selected cell in response to the SNPN selection;
receiving, through the transceiver, a support indication associated with the selected SNPN in response to the cell selection, wherein the support indication indicates whether the selected SNPN supports IP multimedia subsystem (IMS) emergency service;
forwarding the support indication from a radio resource control (RRC) layer of the UE to a non-access stratum (NAS) layer of the UE when the support indication indicates that the selected SNPN supports the IMS emergency service; and
performing the cell selection for an acceptable cell of another SNPN supporting the IMS emergency service when the support indication indicates that the selected SNPN does not support the IMS emergency service.

12. The UE of claim 11, wherein the support indication indicates whether the selected SNPN supports the IMS emergency service over a next-generation radio access network (NG-RAN).

13. The UE of claim 11, wherein the selected SNPN operates the selected cell.

14. The UE of claim 11, wherein the UE is operated in a normal service state for the selected cell, and the support indication is carried in at least one of a NAS message in a registration procedure or system information.

15. The UE of claim 14, wherein the processor is further configured for:
transmitting, through the transceiver, an RRC message having a RRC establishment cause or a RRC resume cause which is set as emergency.

16. The UE of claim 11, wherein the UE is operated in a limited service state for the selected cell, and the support indication is carried in System Information Block 1 (SIB1).

17. The UE of claim 16, wherein the UE is opeated in the limited service when the UE cannot find a suitable cell during the cell selection, and the UE has at least on of emergency services, earthquake and tsunami warning system (ETMS), and commercial mobile alerting system (CMAS) from the selected cell.

18. The UE of claim 11, wherein the processor is further configured for:
determining that the selected SNPN does not support the IMS emergency service for the UE in a limited service state when the support indication indicating that the selected SNPN supports the IMS emergency service is absent.

19. The UE of claim 11, wherein the processor is further configured for:
deactivating the SNPM AM when the acceptable cell of the another SNPN is absent from the cell selection.

20. The UE of claim 11, wherein the processor is further configured for:
performing the cell selection for the acceptable cell of the another SNPN supporting the IMS emergency service when the UE supports a voice service, the UE is operating in the SNPN AM, and the selected cell does not support the IMS emergency service for any SNPN indicated by the support indication.
